(19) United States
(12) Patent Application Publication
(10) Pub. No.: US 2008/0178440 A1
(43) Pub. Date: Jul. 31, 2008

(54) Device and Method for Use in Securing a Load for Transport

(76) Inventor: Darren Lane Douglas, Warner (CA)

Correspondence Address: SHERIDAN ROSS PC, 1560 BROADWAY, SUITE 1200, DENVER, CO, 80202, US

(21) Appl. No.: 11/669,054

(22) Filed: Jan. 30, 2007

(51) Int. Cl. B25B 25/00

(52) U.S. Cl. 24/68 CD

(57) ABSTRACT

A device and method for use in securing a load for transport are described in which a load retaining strap may be thrown over a load in a manner that limits the potential for user injury. Notably, the device includes a strap receptacle for receiving a portion of a load-retaining strap, the strap receptacle operatively attached to a lever member such that application of a throwing or flexing force to the lever member will propel the strap portion from the strap receptacle and over the load. Both the device and method may be customized based on the needs of the user in order to prevent injury and improve safety during transport.

### FIELD OF THE INVENTION

The present invention relates generally to methods to secure loads for transport. More particularly, the present invention relates to a device for use in throwing a length of strap over a load for the purpose of securing the load atop a trailer or other vehicle.

### BACKGROUND OF THE INVENTION

When transporting large or heavy materials, it is critical to properly secure the load to maintain load balance and prevent loss of material. In the trucking industry, avoiding any loss of debris is critical to prevention of accidents and injury of truck drivers and other motorists. Although current recommendations in many industries require that loads be completely contained or covered whenever possible, many large and/or heavy items cannot be easily contained. These items are generally transported on a flatbed trailer and must be secured thereto with straps, chains, and stakes. This places a responsibility on the loading operator and driver to ensure that materials are properly balanced and secured, both at the time of loading and periodically during transport.

Although many advances have been made relating to winches and ratchet systems for tightening straps across a load, the strap must first be thrown over the load prior to tightening. Furthermore, in order to maximize the security of the load, the strap should lie flat over the load and form a straight line from one secured end of the strap to the other. As acceptable load heights for road transport may reach over 13 feet above ground level, proper strap placement may be difficult for many operators, leading to chronic occupational back, neck, and shoulder strain and injury.

In addition to the inconvenience and potential injury to operators in securing loads prior to transport, in short-haul transport or applications requiring repeated delivery of portions of the load, an operator may be required to release and re-secure the straps periodically over the course of one day. Such repetitive physical exertion may cause injury, or, potentially more dangerous, a failure to properly secure subsequent loads leading to load imbalance and/or loss of materials during transport.

Any improvement in the field to ease the physical burden in manually securing a load for transport would be desirable both from a liability and a safety perspective.

### SUMMARY OF THE INVENTION

In a first aspect, the present invention provides a device for assisting an individual in throwing a load-retaining strap over a load, the device comprising a strap receptacle for receiving a portion of a load-retaining strap, the strap receptacle operatively attached to a lever member to which a force may be applied by the user to propel the strap portion from the strap receptacle.

In a suitable embodiment, the lever member is an extension pole, which preferably includes a base, a telescopic arm slidable within the base, and a locking sleeve for locking the position of the telescopic arm with respect to the base.

In a further embodiment, the strap receptacle has a shape, size, and orientation upon the lever member that is suitable for retaining the strap portion therewithin until a throwing force is applied to the lever member by the user to actively propel the strap portion from the strap receptacle.

In a further embodiment, the strap receptacle comprises a concave base and side retention bars suitable for receiving and deploying a length of rolled strap. In such embodiment, the lever member may be attached tangentially to the concave base of the strap receptacle. The strap receptacle, in certain embodiments, may be detachable from the lever member, and may be replaced with other suitable strap receptacles as necessary.

The lever member may suitably be extendable, and may extend to a total length between three and fourteen feet.

In a further embodiment, the device further includes a holster pivotably securable against an independent surface for receiving and stabilizing the base of the lever member during use.

In a second aspect of the invention, there is provided a method for securing a load upon a transport platform comprising the steps of: securing a first end of a load-retaining strap to a first side of a transport platform; placing a portion of the strap within a strap receptacle mounted to a lever member; applying a forward throwing force to the lever member to propel the strap portion from the strap receptacle and over the load; retrieving the second strap end on a second side of the transport platform; securing the second strap end to the second side of the transport platform; and tightening the strap across the load. The method steps may be carried out in any suitable order.

In an embodiment of this aspect of the invention, the method further comprises the step of extending the lever member to a length approximating the height of the top of the load to reduce the amount of force required by the user to propel the strap portion over the load.

In another embodiment, the method further comprises the step of rolling the strap around the second strap end prior to placing the strap within the strap receptacle. In a specific embodiment, application of the forward throwing force causes the rolled strap to drop from the strap receptacle onto the load with a forward momentum sufficient to cause the rolled strap to unroll over the load.

In an additional embodiment, the base of the lever member is stabilized within a holster prior to applying the forward throwing force to the lever member. The holster may be pivotably secured to the ground, to the loading platform, or to the user.

In another embodiment, the strap portion placed into the strap receptacle is the second strap end, to which a weight may be attached prior to throwing the strap end over the load.

In another embodiment, when applying the forward throwing force, the device abuts the load to jar the strap portion from the receptacle.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a perspective view of a device in accordance with an embodiment of the invention; and

FIG. 2 is a schematic diagram of a method for securing a load in accordance with an embodiment of the invention.

### DETAILED DESCRIPTION

Generally, the present invention provides a method and device for securing a large and/or heavy load for transport. The method and device described herein are primarily intended for use by a transport operator in throwing a strap or lashing over the load to secure the load from side to side or end to end. Accordingly, the device includes a strap receptacle for holding a strap portion and a lever member to facilitate lifting and throwing of the strap end.

### Device

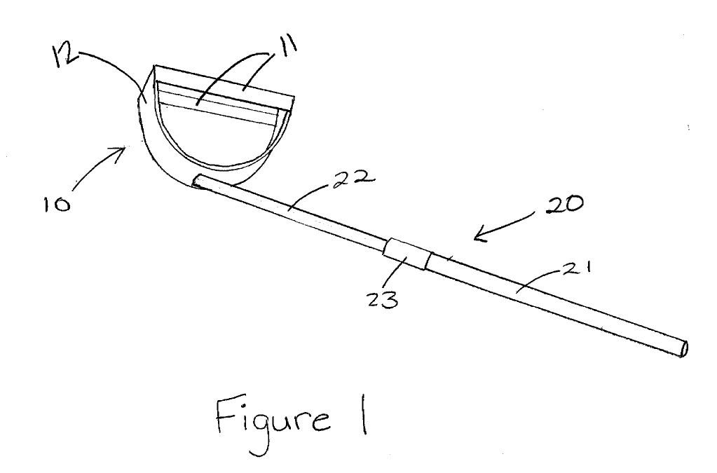

As shown in FIG. 1, a strap thrower in accordance with one embodiment of the invention includes a strap receptacle 10 and a lever member 20. The lever member shown includes a base 21, a telescopic arm 22, and a locking sleeve 23 for locking the position of the telescopic arm with respect to the base.

The lever member, in general, may be constructed of any sturdy, lightweight material such as aluminum, plastic, or fibreglass. It is preferable that the lever member have a certain amount of flexibility such that the user may apply a throwing or snapping motion to the lever to launch or otherwise propel the strap end from the strap receptacle over the load. It is preferable that the lever member be telescopic or otherwise extendable to further facilitate propulsion of the strap end over the load. During use, the lever member is preferably extended to a height similar (within three feet) to the height of the load. As such, the lever member is preferably extendable to a total length of between five and fourteen feet.

The strap receptacle 10 in the embodiment shown is of suitable size to accommodate a length of strap rolled about a strap end. The receptacle 10 includes side retention bars 11 and a concave base 12 to which the telescopic portion 22 of the lever member 20 is attached tangentially as shown. Thus, the concave surface is suitably positioned upon the lever member to prevent dropping of the rolled strap during lifting and extension of the lever member 20, while facilitating release of the rolled strap once lifted, upon application of a throwing or snapping motion by the user. The general shape of the strap receptacle shown is designed to maintain the strap in rolled configuration during manipulation, which will ideally allow the strap to unroll over the load without twisting or tangling. The concave base 12 as well as the width between the side retention bars 11 is slightly wider than that of a rolled strap to allow the strap to unroll easily.

As the length of strap required to secure a load may vary based on the height of the load, the size of the rolled strap may also vary in diameter. The concave base 12 of the strap receptacle 10 is preferably between two and seven inches in depth and between six and fourteen inches wide across the opening. Upon application of a snapping or flexing force to the lever member 20, the strap will be propelled from the receptacle and will unroll over the load.

The material used in construction of the strap receptacle may be rigid or flexible, each having advantages in certain situations. For example, in the embodiment shown in FIG. 1, a rigid material is formed into a concave base 12 to facilitate unrolling of a strap that has been previously rolled about a strap end. In other embodiments, particularly that described below in which a strap end is simply launched over the load to the other side, it may be preferable to use a flexible material such as netting or canvas attached to a sturdy frame to form a sac-like strap receptacle. In this case, more force or more flex within the lever member may be required to launch the strap from the receptacle.

As straps currently used in the field may be of varying weights, widths, and lengths, and strap ends are equally as diverse, the strap receptacle may be designed to accommodate many types of straps or strap ends as desired. Conversely, the strap receptacle may be designed to receive only one type of strap, in which case the receptacle may be detachable from the lever member for replacement with another type of receptacle as needed.

### Alternate Strap Receptacle

Rolling the strap prior to propelling it over the load may be time consuming to the operator. Thus, a strap receptacle may be designed to simply retain a strap end, which may be weighted to ease throwing over the load. The strap end is placed into the strap receptacle, and the remainder of the strap is simply allowed to hang from the receptacle and/or is piled on the ground adjacent the operator. Once the strap end is launched over the load by application of flexion or a snapping force to the lever member, the remainder of the strap will follow the strap end over the load. Accordingly, the lever member may be reduced in length in this application to provide more control of the throwing or snapping motion to the user.

### Optional Holster

In certain applications it may be beneficial to further reduce the stress and effort required by the operator by using a holster to anchor the base of the lever member during throwing or flexing motion. The holster may be secured to the ground, to the loading platform, or to the operator, and receives the lever member base 21 to stabilize the lever member while the operator applies the required force to propel the strap end over the load. The holster is preferably pivotably secured to maximize the range of motion and degree of flexion of the lever member that may be required in certain applications.

### Method

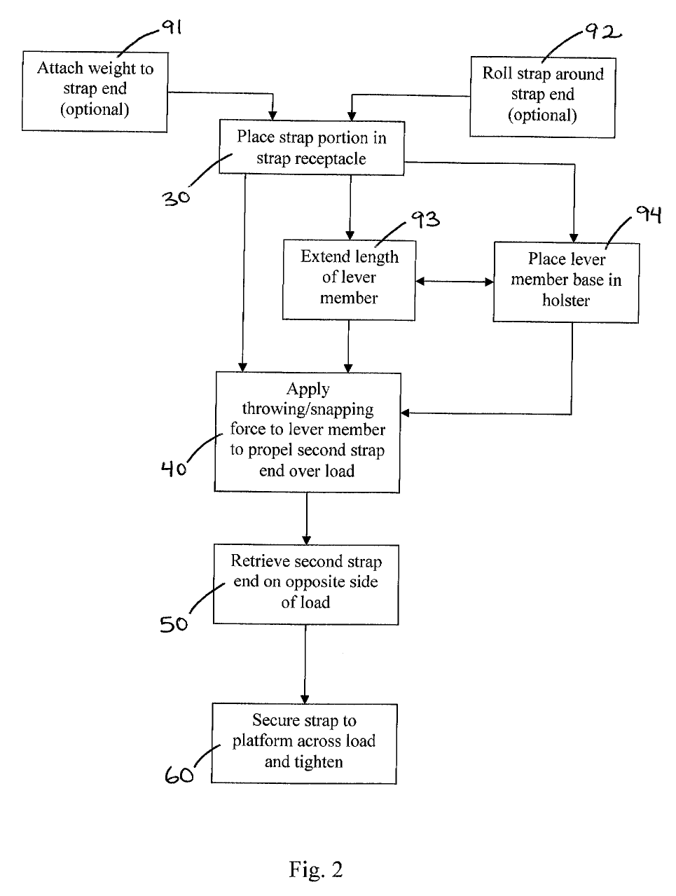

A method for use in securing a load on a platform is indicated in FIG. 2. A user desiring to throw a load-retaining strap over a load in accordance with the invention places 30 a portion of the load-retaining strap in a strap receptacle. The user stands on one side of the load and grasps a lever member attached to the strap receptacle and applies 40 a forward snapping or throwing force to the lever member to propel the strap portion from the strap receptacle and over the load. The user then retrieves 50 the thrown strap on the opposite side of the load, secures 60 the strap to the loading platform, and tightens the strap across the load.

As discussed above, the strap portion placed into the strap receptacle may be a rolled strap portion, a strap end, or a weighted strap end. As such, the method may additionally include the steps of attaching 91 a weight to the strap end, or rolling 92 the strap around the strap end. The decision as to which portion of the strap should be placed in the receptacle may further determine whether the user chooses to lengthen 93 the lever member prior to applying the forward force to same. For example, if the first strap end is initially secured to the load platform and the strap is then rolled from the second strap end, the user may suitably extend 93 the lever member to a height similar to the load height (for example, the lever member may be extended to a total length of thirteen feet) prior to applying 40 a forward flexing force to the lever member to unroll the strap from the receptacle over the load, at which point the strap end will drop to the opposite side of the load.

Alternatively, if the user simply places the second strap end within the strap receptacle, a throwing force may suitably be applied to the lever member in similar manner to a lacrosse player throwing a ball. For such applications, a suitable lever member length may be only four to eight feet as more direct force is required to achieve this type of throwing motion. Therefore, the user may choose not to extend the length of the lever member.

As such, the present device and method may be customized by the user in accordance with the invention. For example, a smaller, weaker, or injury-prone user should roll 92 the strap around the second strap end place 30 the rolled strap in a strap receptacle having a convex base surface as shown in FIG. 1. Such user will benefit from lengthening 93 the lever member to reach the top of the load, and may wish to place 94 the base of the lever member within a holster attached to the ground or to the loading platform to stabilize the lever member. With these variations, the user will be required to exert only minimal effort to flex or advance 40 the lever member until it abuts the load, which will cause the strap to be propelled from the strap receptacle and unroll across the load. While this method may add steps and time to the process of securing the load, proper use of the method will reduce the incidence of injury to the user.

As another example, a stronger user may prefer a sac-like strap receptacle, which is suitably used in accordance with the invention by placing the second strap end in the strap receptacle and applying a leveraged throwing force to the lever member. In this case the goal is to throw the second strap end across the load to land on the opposite side of the load. Some practice may be required to familiarize the user with the amount of force and the appropriate length of the lever member required. This method may be preferred by stronger or more able-bodied users as it includes fewer steps than the above-described method using a rolled strap.

Notably, several additional variations to the above-described methods are possible and will be apparent to the user upon reading the present description. A user may thus select a device design and method that is most suitable to their needs.

The user may wish to secure the first strap end to the platform prior to throwing the second end over the load. Alternatively, both ends may be secured after the strap has been thrown over the load. The step of securing the strap ends on either side of the platform may be achieved by methods well known in the art. For example, most flatbed trailers are equipped with hooks or fasteners as well as ratchet or winch devices for tightening straps or chains across a load.

The present device and method may be used to secure loads atop various loading platforms, including flatbed trailers, rail cars, truck beds, roof racks, pallets, skids, and the like for transport by road rail, air, or over water.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A device for assisting an individual in throwing a load-retaining strap over a load, the device comprising a strap receptacle for receiving a portion of a load-retaining strap, the strap receptacle operatively attached to a lever member to which a force may be applied by the user to propel the strap portion from the strap receptacle.

2. The device as in claim 1, wherein the lever member is an extension pole.

3. The device as in claim 1, wherein the lever member includes a base, a telescopic arm slidable within the base, and a locking sleeve for locking the position of the telescopic arm with respect to the base.

4. The device as in claim 1, wherein the strap receptacle has a shape, size, and orientation upon the lever member that is suitable for retaining the strap portion therewithin until a throwing force is applied to the lever member by the user to actively propel the strap portion from the strap receptacle.

5. The device as in claim 1, wherein the strap receptacle comprises a concave base and side retention bars suitable for receiving and deploying a length of rolled strap.

6. The device as in claim 5, wherein the lever member is attached tangentially to the concave base of the strap receptacle.

7. The device as in claim 1, wherein the lever member is between three and fourteen feet in length.

8. The device as in claim 2, wherein the lever member is extendable to a length of at least six feet.

9. The device as in claim 1 wherein the strap receptacle is detachable from the lever member.

10. The device as in claim 1, further comprising a holster pivotably securable against an independent surface for receiving and stabilizing the base of the lever member during use.

11. A method for securing a load upon a transport platform comprising the steps of:
securing a first end of a load-retaining strap to a first side of a transport platform;
placing a portion of the strap within a strap receptacle mounted to a lever member;
applying a forward throwing force to the lever member to propel the strap portion from the strap receptacle and over the load;
retrieving the second strap end on a second side of the transport platform;
securing the second strap end to the second side of the transport platform; and
tightening the strap across the load.

12. The method as in claim 11, further comprising the step of extending the lever member to a length approximating the height of the top of the load to reduce the amount of force required by the user to propel the strap portion over the load.

13. The method as in claim 11, further comprising the step of rolling the strap around the second strap end prior to placing the strap within the strap receptacle.

14. The method as in claim 13 wherein application of the forward throwing force causes the rolled strap to drop from the strap receptacle onto the load with a forward momentum sufficient to cause the rolled strap to unroll over the load.

15. The method as in claim 11, further comprising the step of stabilizing the base of the lever member within a holster prior to applying the forward throwing force to the lever member.

16. The method as in claim 15, wherein the holster is pivotably secured to the ground, to the loading platform, or to the user.

17. The method as in claim 11 wherein the strap portion is the second strap end.

18. The method as in claim 17 wherein a weight is attached to the strap end prior to throwing the strap end over the load.

19. The method as in claim 11 wherein the forward throwing force causes the device to abut the load, jarring the strap portion from the receptacle.
